(19) United States
(12) Patent Application Publication
(10) Pub. No.: US 2015/0321508 A1
(43) Pub. Date: Nov. 12, 2015

(54) WHEEL LIGHT RING

(71) Applicant: Robert Henderson, Beacon, NY (US)

(72) Inventor: Robert Henderson, Beacon, NY (US)

(21) Appl. No.: 14/273,678

(22) Filed: May 9, 2014

(51) Int. Cl. B60B 7/00; B60B 7/01

(52) U.S. Cl. CPC B60B 7/006; B60B 7/01; B60B 2900/572

(57) ABSTRACT

A wheel light ring for installation within a wheel comprising: a series of LED lights where the series of LED lights include a connecting wire; and a steel ring, where the steel ring supports the series of LED lights and said steel ring installs on an inner diameter of the wheel. Preferably, the steel ring surrounds a rotor within the inner diameter of the wheel. In one particular embodiment, the diameter of the steel ring is smaller than a diameter of an outer rim of the wheel and the connecting wire connects to DC power.

### BACKGROUND OF THE INVENTION

1. Field of Invention

The present invention relates to a steel ring that includes a series of LED lights for mounting on an inside diameter of a vehicle wheel.

2. Description of Related Art

Wheels and rims are necessary to support tires on various vehicles, in particular, cars and trucks. The normal operation of a wheel and rim is placement onto lug nuts that mount the wheel and rim into place for rotation. Further a tire is mounted over the rim, where the rim may come in assorted styles and colors. Some wheels and rims are fairly generic and require wheel covers, i.e. hubcaps for decorative and aesthetic purposes. Other wheels are custom made with particular designs such as chrome, brushed steel or polished aluminum for customized looks. A number of car enthusiasts spend a considerable amount of time and money to customize their wheels and rims for distinct looks. As a consequence many enthusiasts are looking for new innovations to adorn and customize their wheels for their particular vehicles.

### SUMMARY OF THE INVENTION

The present invention relates to a wheel light ring for installation within a wheel comprising: a series of LED lights where the series of LED lights include a connecting wire; and a steel ring, where the steel ring supports the series of LED lights and said steel ring installs on an inner diameter of the wheel. Preferably, the steel ring surrounds a rotor within the inner diameter of the wheel. In one particular embodiment, the diameter of the steel ring 30 is smaller than a diameter of an outer rim of the wheel and the connecting wire connects to DC power.

### BRIEF DESCRIPTION OF DRAWINGS

FIG. 1 depicts use of a wheel light ring in accordance with the present invention.

FIG. 2 depicts an interior view of a wheel that has incorporated the wheel light ring in accordance with the present invention.

FIG. 3 depicts a steel ring that is used to mount a series of LED lights to create the wheel light ring in accordance with the present invention.

### DETAILED DESCRIPTION

The present invention relates to a wheel light ring that is incorporated into a standard or a customized wheel. In the preferred embodiment, the wheel light ring is incorporated into the wheel that includes enough visual openings to allow visibility of the series of LED lights that make up the body of the ring. The wheel light ring includes a steel ring that is installed on the interior of the wheel around the brake rotor. A series of LED lights are installed around the ring and power is supplied to the lights via the battery of the vehicle. Once installed on the interior diameter of the wheel the lights may be illuminated and provide further aesthetic styling of the wheels on the vehicle.

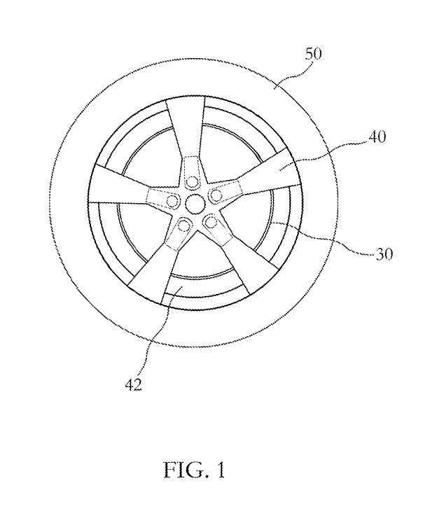

In reference to FIG. 1, a wheel light ring 30 in accordance with the present invention is shown that is installed within a wheel 40. The wheel light ring 30 is installed on an interior diameter of the wheel 40 and provides illumination and further adornment of the wheel during use. An outer rim 42 of the wheel 40 meets and supports a tire 50 as shown in FIG. 1. FIG. 1 depicts the completed ensemble of the wheel light ring 30 incorporated with wheel 40.

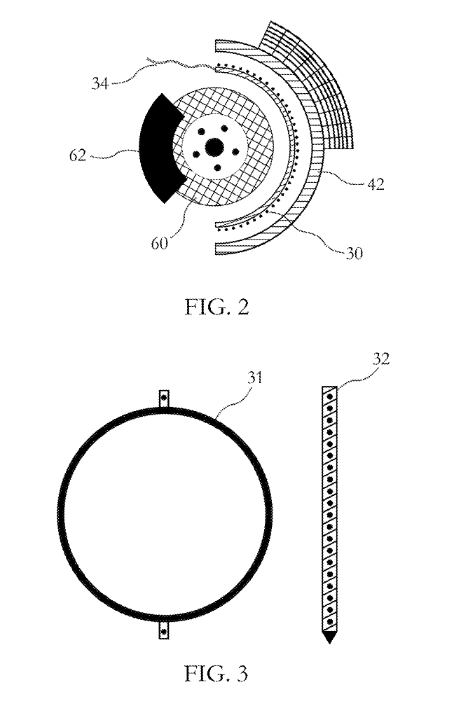

With respect to FIG. 2, a sectional view of the wheel and tire is shown exposing a rotor 60 and caliper 62. As shown the wheel ring 30 surrounds the rotor 60 within the inner diameter of the wheel 40. The diameter of the light ring 30 is smaller than the outer rim 42 as shown. The series of LED lights are shown with a connecting wire 34 that connects to DC power supplied by the battery of the vehicle.

The LED lighting 30 is supported on a steel ring 31 as shown in FIG. 3. The steel ring 31 surrounds the rotor 60 and is mounted within the interior of the wheel 40. The diameter of the ring 31 is customized to accommodate various size wheels and rotors in order to ensure visibility during use. The instant invention has been shown and described in what it considers to be the most practical and preferred embodiments. It is recognized, however, that departures may be made there from within the scope of the invention and that obvious modifications will occur to a person skilled in the art.

What is claimed is:

1. A wheel light ring for installation within a wheel comprising:
a. a series of LED lights where the series of LED lights include a connecting wire; and
b. a steel ring, where the steel ring supports the series of LED lights and said steel ring installs on an inner diameter of the wheel.

2. The wheel light ring according to claim 1, where the steel ring surrounds a rotor within the inner diameter of the wheel.

3. The wheel light ring according to claim 1, where the diameter of the steel ring is smaller than a diameter of an outer rim of the wheel.

4. The wheel light ring according to claim 1, where the connecting wire connects to DC power.
